(19) United States
(12) Patent Application Publication
(10) Pub. No.: US 2006/0130621 A1
(43) Pub. Date: Jun. 22, 2006

(54) Multi-tool screwdriver

(75) Inventors: Joseph Novak, Longmeadow, MA (US); Asif Elliston, Springfield, MA (US)

Correspondence Address: MCCARTER & ENGLISH LLP;CITYPLACE I, 185 ASYLUM STREET, HARTFORD, CT, 06103, US

(73) Assignee: Irwin Industrial Tool Company

(21) Appl. No.: 11/285,542

(22) Filed: Nov. 21, 2005

Related U.S. Application Data
(60) Provisional application No. 60/630,171, filed on Nov. 22, 2004.

(51) Int. Cl. B25B 23/00; B25B 15/00

(52) U.S. Cl. 81/439; 81/436

(57) ABSTRACT

A multi-tool screwdriver includes a handle, a multi-tool shaft and a hexagonal-shaped sleeve. The handle defines a shaft opening therein for receiving and securing the multi-tool shaft to the handle. The multi-tool shaft includes a hexagonal shaped driver on both ends thereof, each driver adapted to receive a driver bit. The hexagonal-shaped sleeve is receivable within at least one of the multi-tool shaft drivers and includes a hexagonal shaped driver on both ends thereof, each driver adapted to receive a driver bit. An impact resistant insert is disposed within the handle to absorb impact forces and prevent the multi-tool shaft and/or bits stored in the handle from penetrating the handle when the handle is struck by a hammer or other object when the multi-tool screwdriver is used, for example, as a chisel or punch.

### CROSS REFERENCE TO RELATED APPLICATIONS

This application claims priority to U.S. Provisional Patent Application No. 60/630,171, filed Nov. 22, 2004, entitled “Multi-Tool Screwdriver”, which is hereby expressly incorporated by reference as part of the present disclosure.

### FIELD OF THE INVENTION

The present invention relates to multi-tool screwdrivers, and more particularly, to multi-tool screwdrivers including a handle, a multi-tool shaft receivable within the handle and defining hexagonal-shaped drivers on the end portions of the multi-tool shaft, a hexagonal-shaped sleeve receivable in a hexagonal-shaped driver of the multi-tool shaft and defining hexagonal-shaped drivers on the end portions of the sleeve, and a plurality of hexagonal-shaped tool bits receivable within the hexagonal-shaped drivers of the multi-tool shaft and sleeve.

### BACKGROUND INFORMATION

A typical multi-tool screwdriver includes a handle; a multi-tool shaft receivable within the handle and including a first hexagonal-shaped driver on one end, and a second hexagonal-shaped driver on the other end; a hexagonal-shaped sleeve receivable in a hexagonal-shaped driver of the multi-tool shaft, and including a third hexagonal-shaped driver on one end and a fourth hexagonal-shaped driver on the other end; and a plurality of hexagonal-shaped tool bits receivable within the hexagonal shaped drivers of the multi-tool shaft and sleeve. Typically, one end of the multi-tool shaft, including a tool bit and/or a sleeve and one or more tool bits received therein, is received within an interior portion of the handle for storage, while the other end of the multi-tool shaft extends outwardly of the handle, and includes a tool bit, and/or a sleeve and one or more tool bits received in the sleeve, for usage. Thus, the multi-tool screwdriver holds within the handle and/or the exposed end of the multi-tool shaft a plurality of tool bits. A typical commercially available multi-tool screwdriver provides at least six tools in one screwdriver. The position of the multi-tool shaft within the handle can be easily changed to expose a desired end of the multi-tool shaft and to store the other end of the multi-tool shaft within the handle to thereby select a desired size and/or type of tool bit for usage.

One such multi-tool screwdriver is shown in U.S. Pat. No. 5,904,080 to Anderson et al. (the '080 patent). In the teachings of the '080 patent, and various known commercially available multi-tool screwdrivers, the multi-tool shaft includes a 5/16 inch wide hexagonal-shaped driver on one end, and a ¼ inch wide hexagonal-shaped driver on the other end. As a result, the multi-tool screwdriver can include at least six, if not more tools in one screwdriver. For example, the '080 patent states that the most popular nut drivers are the ¼ inch and 5/16 inch wide nut drivers. Accordingly, the conventional multi-tool shaft having a 5/16 inch driver on one end and a ¼ inch driver on the other end permits the multi-tool screwdriver to hold at least three double ended bits, and thus provide at least 6 tools in one screwdriver. One 5/16 inch bit defining two tools is receivable in one end of the multi-tool shaft, one ¼ inch bit defining another two tools is receivable in the other end of the multi-tool shaft, and another double ended bit that is either ¼ inch wide or 3/16 inch wide is receivable in an exposed end of the sleeve, depending on whether the outside of the sleeve is dimensioned to be received within the 5/16 inch or ¼ inch driver of the multi-tool shaft. Some such multi-tool screwdrivers include more than one sleeve, and permit up to 10 tools one multi-tool screwdriver.

One of the drawbacks of such conventional multi-tool screwdrivers is that both the multi-tool shaft and the hexagonal-shaped sleeve received within one end of the shaft define relatively thin wall thicknesses (for example, only about 1/32 of an inch at the radius), and therefore such multi-tool shafts and hexagonal-shaped sleeves are more flimsy than otherwise desired. As a result, such multi-tool shafts and sleeves may tend to flex more than desired during usage, may not permit as much torque or force to be applied during usage than otherwise desired, and/or may wear or break sooner than otherwise desired.

Another drawback of such conventional multi-tool screwdrivers is that the handle is not capable of withstanding impact forces when a user strikes the butt end of the handle with a hammer or other object when the screwdriver is used, for example, as a chisel or punch. In such instances, the handle either breaks apart or the shaft penetrates into or through the butt end of the handle, thereby rendering the tool useless.

Accordingly, it is an object of the present invention to overcome one or more of the above-described drawbacks and/or disadvantages of prior art multi-tool screwdrivers.

### SUMMARY OF THE INVENTION

In accordance with one aspect, the present invention is directed to a multi-tool screwdriver comprising a handle defining a shaft opening therein, and a multi-tool shaft defining an outer diameter greater than about ½ of an inch and receivable within the shaft opening of the handle for securing the multi-tool shaft to the handle. The multi-tool shaft includes on a first end thereof a first approximately hexagonal-shaped driver defining a first width of about ⅜ of an inch and adapted to receive therein an approximately ⅜ inch wide bit, and includes on a second end thereof a second approximately hexagonal-shaped driver defining a second width of about 5/16 of an inch and adapted to receive therein an approximately 5/16 inch wide bit. An approximately hexagonal-shaped sleeve of the multi-tool screwdriver defines an external width of about ⅜ of an inch, and includes on a first end thereof a third approximately hexagonal-shaped driver defining a third width between opposing surfaces, and includes on a second end thereof a fourth approximately hexagonal-shaped driver defining a fourth width between opposing surfaces. The third and fourth widths are each less than or equal to about ¼ of an inch, and the third and fourth approximately hexagonal-shaped drivers are each adapted to receive therein an approximately hexagonal-shaped bit defining a width of about ¼ of an inch or less. Each of the first and second ends of the hexagonal-shaped sleeve are receivable within the first hexagonal-shaped driver of the multi-tool shaft.

In accordance with another aspect, the present invention is directed to a multi-tool screwdriver comprising a handle defining a shaft opening therein, and a multi-tool shaft defining an outer diameter greater than about ½ of an inch and receivable within the shaft opening of the handle for securing the multi-tool shaft to the handle. The multi-tool shaft includes on a first end thereof a first approximately hexagonal-shaped driver defining a first width within the range of about 0.35 inch to about 0.39 inch and adapted to receive therein a bit defining a width within the range of about 0.35 inch to about 0.39 inch. The multi-tool shaft includes on a second end thereof a second approximately hexagonal-shaped driver defining a second width within the range of about 0.27 inch to about 0.32 inch and adapted to receive therein a bit defining a width within the range of about 0.27 inch to about 0.32 inch. The multi-tool screwdriver further includes an approximately hexagonal-shaped sleeve defining an external width within the range of about 0.35 inch to about 0.39 inch. The sleeve includes on a first end thereof a third approximately hexagonal-shaped driver defining a third width between opposing surfaces, and includes on a second end thereof a fourth approximately hexagonal-shaped driver defining a fourth width between opposing surfaces. The third and fourth widths are each less than or equal to about ¼ of an inch, and the third and fourth approximately hexagonal-shaped drivers are each adapted to receive therein an approximately hexagonal-shaped bit defining a width of about ¼ of an inch or less. Each of the first and second ends of the hexagonal-shaped sleeve is receivable within the first hexagonal-shaped driver of the multi-tool shaft.

In accordance with still another aspect of the invention, the multi-tool screwdriver includes an insert disposed within the handle. The insert is impact resistant and/or shock absorbing to prevent the multi-tool screwdriver from being damaged by impact forces imparted on the handle when a user strikes the handle with a hammer or other object while using the multi-tool screwdriver as, for example, a chisel or punch.

In one embodiment of the present invention, the multi-tool screwdriver further comprises at least two approximately ¼ inch wide, substantially hexagonal-shaped tool bits receivable within each of the third and fourth approximately hexagonal-shaped drivers of the sleeve, at least one approximately ⅜ inch wide, substantially hexagonal-shaped tool bit receivable within the first approximately hexagonal-shaped driver of the multi-tool shaft, and at least one approximately 5/16 inch wide, substantially hexagonal-shaped tool bit receivable within the second approximately hexagonal-shaped driver of the multi-tool shaft.

In another embodiment of the present invention, the first width of the multi-tool shaft is within the range of about 9 mm to about 10 mm, the second width of the multi-tool shaft is within the range of about 7 mm to about 8 mm, and the external width of the hexagonal-shaped sleeve is within the range of about 9 mm to about 10 mm.

One advantage of the multi-tool screwdriver of the present invention is that the multi-tool shaft defines an approximately ⅜ inch or 9 mm hexagonal-shaped driver on one end, and an approximately 5/16 inch or 7 mm hexagonal-shaped driver on the other end, and further, the hexagonal-shaped sleeve is approximately ⅜ inch or 9 mm wide. As a result, the multi-tool shaft and hexagonal-shaped sleeve of the multi-tool screwdrivers of the present invention define significantly greater wall thicknesses than do the shafts and sleeves of known prior art multi-tool screwdrivers, thus providing a substantially sturdier construction while nevertheless permitting at least nine tools to be included in one such screwdriver.

Other objects and advantages of the multi-tool screwdrivers of the present invention will become more readily apparent in view of the following detailed description of the currently preferred embodiments and accompanying drawings.

### BRIEF DESCRITPION OF THE DRAWINGS

FIG. 1 is an exploded, perspective view of the handle assembly of a multi-tool screwdriver of the present invention.

FIG. 2 is an end elevational view of the handle assembly of FIG. 1.

FIG. 3 is a side elevational view of the handle assembly of FIG. 1.

FIG. 4 is a side elevational view of a multi-tool shaft of a multi-tool screwdriver of the present invention.

FIG. 5 is a top plan view of the multi-tool shaft of FIG. 4.

FIG. 6 is a cross-sectional view of the multi-tool shaft of FIG. 4.

FIG. 7 is an end elevational view of the multi-tool shaft of FIG. 4.

FIG. 8 is an opposite end elevational view of the multi-tool shaft of FIG. 4.

FIG. 9 is a perspective view of a hexagonal-shaped sleeve of a multi-tool screwdriver of the present invention.

FIG. 10 is a side elevational view of the hexagonal-shaped sleeve of FIG. 9.

FIG. 11 is an end elevational view of the hexagonal-shaped sleeve of FIG. 9.

FIG. 12 is a perspective view of a ¼ inch double ended combination bit of a multi-tool screwdriver of the present invention.

FIG. 13 is an end elevational view of the bit of FIG. 12.

FIG. 14 is a perspective view of a 5/16 inch double ended combination bit of a multi-tool screwdriver of the present invention.

FIG. 15 is an end elevational view of the bit of FIG. 14.

FIG. 16 is a perspective view of a ⅜ inch double ended combination bit of a multi-tool screwdriver of the present invention.

FIG. 17 is an end elevational view of the bit of FIG. 16.

FIG. 18 is a perspective view of another ⅜ inch double ended combination bit of a multi-tool screwdriver of the present invention.

FIG. 19 is an end elevational view of the bit of FIG. 18.

FIG. 20 is a side view of the handle assembly of FIG. 1 with a partial cutaway showing the impact resistant insert.

### DETAILED DESCRIPTION OF THE CURRENTLY PREFERRED EMBODIMENTS

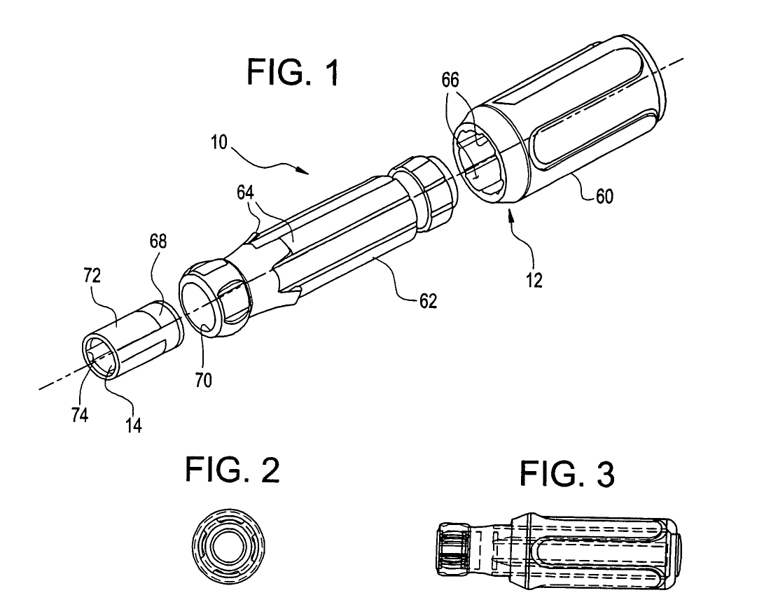

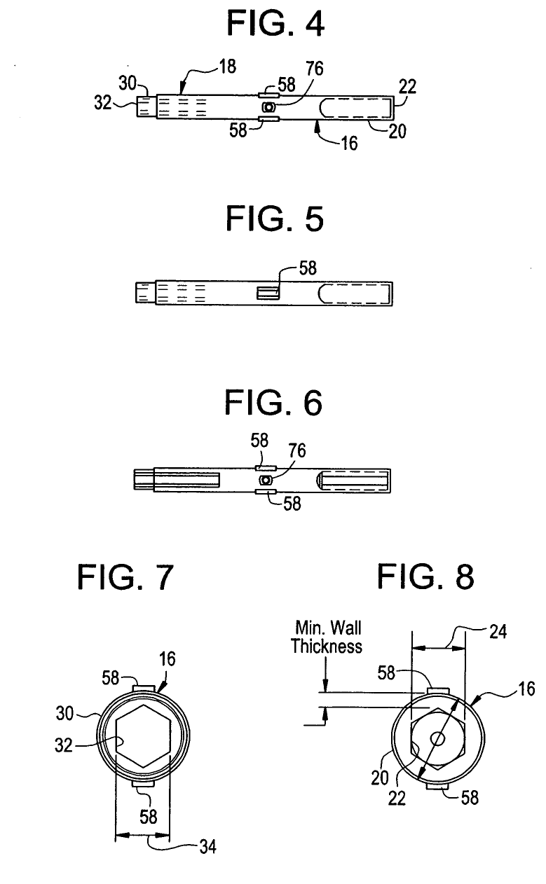

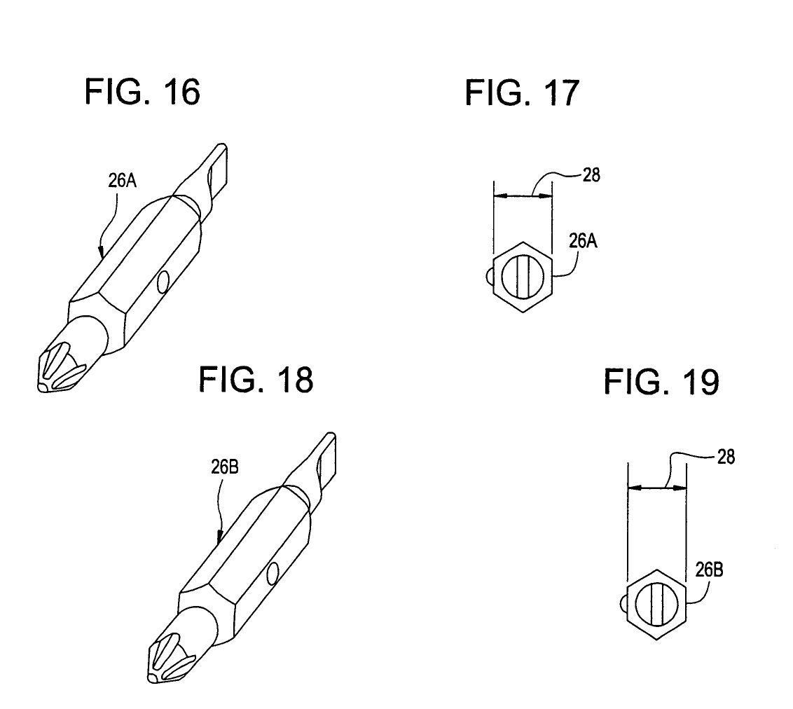

In FIGS. 1-20, a multi-tool screwdriver embodying the present invention is indicated generally by the reference numeral 10. As shown in FIGS. 1-8, the multi-tool screwdriver 10 comprises a handle 12 defining a shaft opening 14 therein, and a multi-tool shaft 16 defining an outer diameter 18 greater than about ½ of an inch and receivable within the shaft opening 14 of the handle 12 for securing the multi-tool shaft 16 to the handle. As shown in FIGS. 4-8, the multi-tool shaft 16 includes on a first end 20 thereof a first approximately hexagonal-shaped driver 22 defining a first width 24 (FIG. 8) within the range of about 0.35 inch to about 0.39 inch, and adapted to receive therein a bit 26A or 26B (FIGS. 16-19) defining a width 28 within the range of about 0.35 inch to about 0.39 inch. The multi-tool shaft 16 includes on a second end 30 thereof a second approximately hexagonal-shaped driver 32 defining a second width 34 (FIG. 7) within the range of about 0.27 inch to about 0.32 inch, and adapted to receive therein a bit 36 (FIGS. 14 and 15) defining a width 38 within the range of about 0.27 inch to about 0.32 inch.

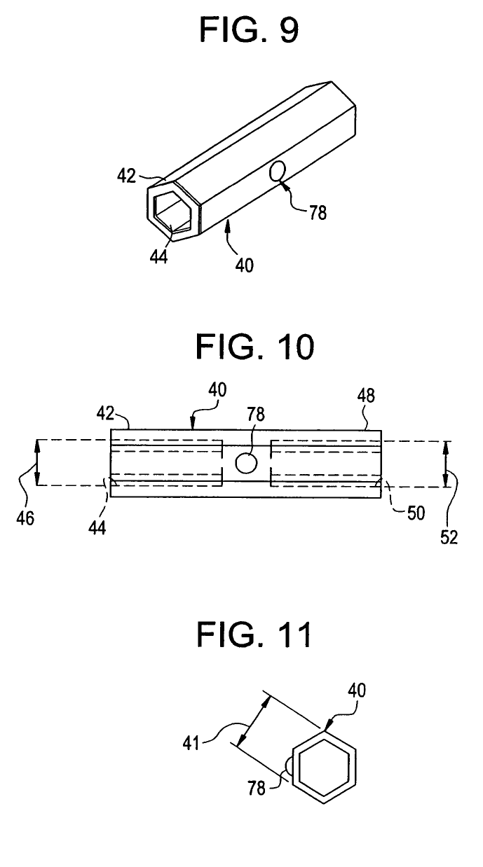

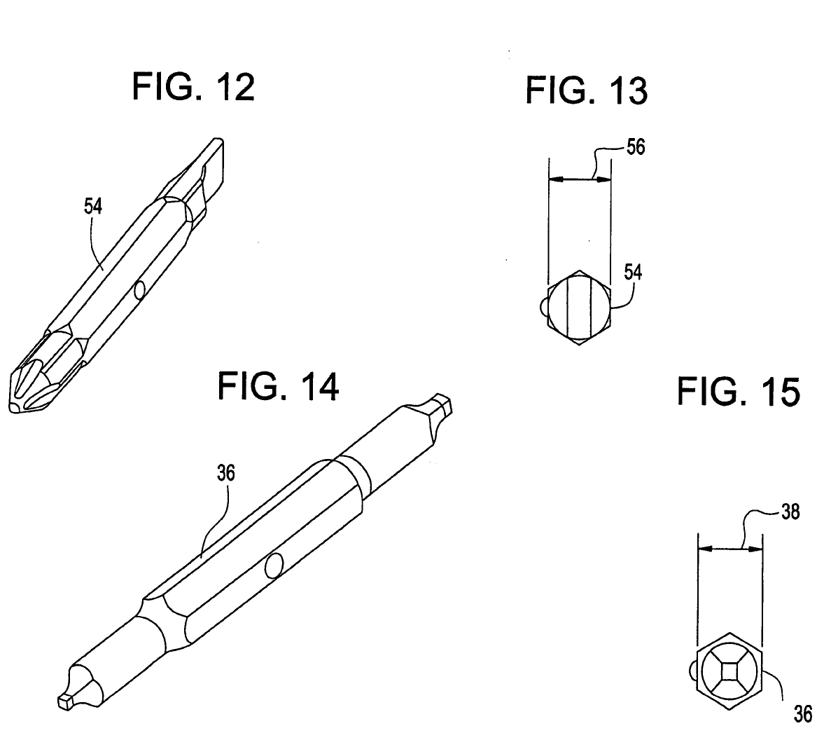

As shown in FIGS. 9-11, an approximately hexagonal-shaped sleeve 40 of the multi-tool screwdriver 10 defines an external width 41 (FIG. 11) within the range of about 0.35 inch to about 0.39 inch. The sleeve 40 includes on a first end 42 thereof a third approximately hexagonal-shaped driver 44 defining a third width 46 (FIG. 10) between opposing surfaces, and including on a second end 48 thereof a fourth approximately hexagonal-shaped driver 50 defining a fourth width 52 (FIG. 10) between opposing surfaces. The third and fourth widths 46 and 52, respectively, are each less than or equal to about ¼ of an inch, and the third and fourth approximately hexagonal-shaped drivers 44 and 50, respectively, are each adapted to receive therein an approximately hexagonal-shaped bit 54 (FIGS. 12 and 13) defining a width 56 of about ¼ of an inch or less. Each of the first and second ends 42 and 48, respectively, of the hexagonal-shaped sleeve 40 are receivable within the first hexagonal-shaped driver 22 of the multi-tool shaft 16.

In one embodiment of the present invention, the multi-tool screwdriver 10 is dimensioned in U.S. Customary and British Imperial units. In this embodiment, the multi-tool shaft defines a first width 24 (FIG. 8) of about ⅜of an inch, a second width 28 (FIG. 7) of about 5/16 of an inch, the bits 26A and 26B (FIGS. 16-19) define a width 28 of about ⅜ of an inch, the bit 36 (FIGS. 14-15) defines a width 38 of about 5/16 of an inch, the hexagonal-shaped sleeve 40 (FIGS. 9-11) defines an external width 41 of about 3/8 of an inch, and third and fourth widths 46 and 52, respectively, of about ¼ inch, and the bit 54 (FIGS. 12 and 13) defines a width 56 of about ¼ inch.

In another embodiment of the present invention, the multi-tool screwdriver is dimensioned in metric units. In this embodiment, the multi-tool shaft defines a first width 24 (FIG. 8) of about 9 mm, a second width 28 (FIG. 7) of about 7 mm, the bits 26A and 26B (FIGS. 16-19) define a width 28 of about 9 mm, the bit 36 (FIGS. 14-15) defines a width 38 of about 7 mm, the hexagonal-shaped sleeve 40 (FIGS. 9-11) defines an external width 41 of about 7 mm, and third and fourth widths 46 and 52, respectively, of about 6 mm, and the bit 54 (FIGS. 12 and 13) defines a width 56 of about 6 mm.

In the currently preferred embodiments of the present invention, the multi-tool shaft defines a minimum wall thickness at the 5/16 inch end thereof of at least approximately 0.04 inch (and in the illustrated embodiment is approximately 0.047 inch), and the hexagonal-shaped sleeve 40 defines a minimum wall thickness at each of the ends 42 and 48 thereof of at least approximately 0.06 inch (and in the illustrated embodiment is approximately 0.0615 inch).

As shown in FIGS. 4-8, the multi-tool shaft 16 includes two guide protuberances 58 located midway between the first and second ends 20 and 30 of the shaft, and formed on diametrically opposite sides of the shaft relative to each other. As can be seen, each guide protuberance 58 is approximately rectangular shaped, and extends in the axial direction of the shaft.

As shown in FIGS. 1-3, the handle 12 includes a manually engageable grip 60, and an axially-elongated handle sleeve 62 that is slidably received within the grip 60. The handle sleeve 62 defines a plurality of angularly spaced, axially-extending ribs 64 that are received within corresponding axially-extending grooves 66 of the grip to prevent relative rotation of the handle sleeve and grip. The handle sleeve 62 further defines an open end 70 and a butt end 71. A driver grip 68 is press-fit into the open end 70 of the handle sleeve 62 and defines the shaft opening 14 therein. As can be seen, the driver grip 68 includes an annular knurled portion 72 that frictionally engages the open end 70 of the handle sleeve to fixedly secure the driver grip within the sleeve. The driver grip 68 defines two diametrically opposed, axially-extending guide recesses 74 (only one shown in FIG. 1) for receiving therein the guide protuberances 58 of the shaft 16 with one end of the shaft received within the shaft opening 14 of the handle 12.

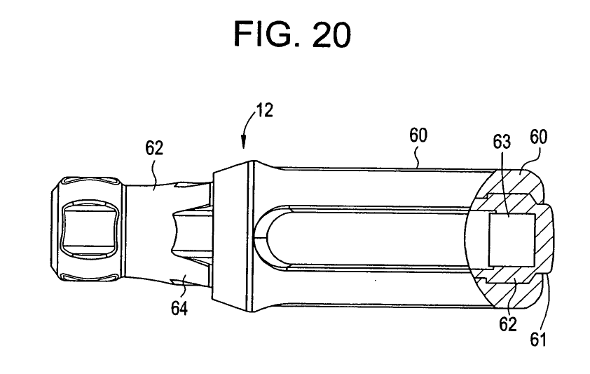

As shown in FIG. 20, the handle 12 further includes an impact resistant insert 63 that is press fit into the butt end 61 of the handle sleeve 62. In a preferred embodiment of the present invention, the insert 63 is a steel plug or core approximately cylindrical in shape; however, the insert can come in a variety of shapes and be formed from a variety of materials (metal or non-metal) so long as the insert is hard enough to prevent the multi-shaft 16 (FIG. 1) and/or a driver bit (described in further detail below) received within the end of the shaft 16 inserted into the handle 12, or stored in the handle 12 separate from the shaft 16, from penetrating the handle sleeve 62 and/or grip 60, when the user strikes the butt end 61 of the handle 12 with a hammer or other object when the multi-tool screwdriver 10 is used, for example, as a chisel or punch. In another embodiment, the insert 63 is made from a shock absorbing material, that, in addition to preventing the shaft 16 and/or bits from penetrating the handle sleeve 62 and/or grip 60, will act as a shock absorber or dampener to prevent impact forces and vibrations from damaging the handle 12, the multi-tool shaft 16, the driver grip 68, the hexagonal-shaped sleeve 40 and any other component of the multi-tool screwdriver 10, including the driver bits, when the multi-tool screwdriver 10 is used as a chisel or punch. In yet another embodiment of the invention, the handle sleeve 62 is made from any impact resistant material that is capable of supporting the multi-tool shaft 16, while at the same time capable of preventing the shaft 16 and/or driver bits received within the end of the shaft 16 inserted into the handle 12, or stored in the handle 12 separate from the shaft 16, from penetrating the handle sleeve 62 and/or grip 60, when the user strikes the butt end 61 of the handle 12 with a hammer or other object when the multi-tool screwdriver 10 is used, for example, as a chisel or punch. In this embodiment, the inert 63 is optionally present, and can function as an additional impact resistant member and/or a shock absorbing member.

As shown in FIGS. 4-8, the multi-tool shaft 16 includes a locking member 76 that is located midway between the ends 20 and 30 thereof, and is biased into contact with a corresponding recess (not shown) formed within the driver grip 68 to prevent relative axial movement of the multi-tool shaft 16 and handle 12. In the illustrated embodiment, the locking member 76 is a ball received within a recess formed within the side wall of the multi-tool shaft 16, and a coil spring is seated between the ball and base of the recess to bias the ball radially outwardly of the shaft. The edges of the recess formed in the side wall of the multi-tool shaft 16 are staked, pressed, stamped or otherwise deformed to retain the ball within the recess. As shown in FIGS. 9-11, the hexagonal-shaped sleeve 40 also includes a locking member 78 for releasably retaining the sleeve in the shaft and that is located about midway between the ends 42 and 48 of the sleeve. The locking member 78 of the hexagonal-shaped sleeve 78 is constructed in same manner as, or similar to the locking member 76 of the multi-tool shaft 16. As shown in FIGS. 12-19, the various bits used with the multi-tool shaft 16 and hexagonal-shaped sleeve 40 likewise include locking members 80 for releasably retaining the bits within the drivers of the hexagonal-shaped sleeve or multi-tool shaft. The locking members 80 each are constructed in the same manner as, or similar to the locking members 76 and 78 described above. As may be recognized by those of ordinary skill in the pertinent art based on the teachings herein, the illustrated locking members and corresponding structure formed in the handle, multi-tool shaft, and hexagonal-shaped sleeve are only exemplary, and numerous other mechanisms that are currently known, or that later become known for performing the function of the locking members disclosed herein equally may be employed in the multi-tool screwdriver of the present invention. In addition, the locking members may be located either symmetrically on the multi-tool shaft, hexagonal-shaped sleeve, and tool bits, as shown, or one or more of these locking members may be located non-symmetrically on the multi-tool shaft, hexagonal-shaped sleeve and/or bit, as desired or otherwise required.

Accordingly, as can be seen, the multi-tool screwdriver 10 comprises at least two approximately ¼ inch wide (or 6 mm wide), substantially hexagonal-shaped tool bits 54 (FIGS. 12 and 13) receivable within each of the third and fourth approximately hexagonal-shaped drivers 44 and 50 of the hexagonal-shaped sleeve 40, at least one approximately ⅜ inch wide (or 9 mm wide) 26A or 26B (FIGS. 16-19), substantially hexagonal-shaped tool bit receivable within first approximately hexagonal-shaped driver 22 of the multi-tool shaft 16, and at least one approximately 5/16 inch wide (or 7 mm wide), substantially hexagonal-shaped tool bit 36 (FIGS. 14 and 15) receivable within the second approximately hexagonal-shaped driver 32 of the multi-tool shaft 16. As can be seen, each of the illustrated tool bits is a double ended bit. As shown in FIGS. 12 and 13, the bit 54 defines on one end a slotted screw head (e.g., a 1/4 inch slotted head), and defines on the other end a Philips screw head (e.g., a #2 Philips head). As shown in FIGS. 14 and 15, the bit 36 is a double ended square bit, defining a first square bit one end (e.g., a # 1 square bit), and another square bit on the other end (e.g., a # 2 square bit). As shown in FIGS. 16 and 17, the bit 26A is a double ended combination bit defining a slotted screwdriver head on one end (e.g., a 9/32 inch slotted head), and a Philips screwdriver head on the other end (e.g., a # 2 Philips head). As shown in FIGS. 18 and 19, the bit 26B is a double end combination bit defining a slotted screwdriver head on one end (e.g., a 3/16 inch slotted head), and a Philips screwdriver head on the other end (e.g., a # 1 Philips head). Accordingly, the multi-tool screwdriver of the present invention provides at least 9 tools in one screwdriver, i.e., 3 nut drivers and 6 bits.

In use, either end 20 or 30 of the multi-tool shaft 16 is receivable within the shaft opening 14 of the handle 12 with either a ⅜ inch bit 26A or 26B or the hexagonal-shaped sleeve 40 received within the first driver 22 thereof, wherein the hexagonal-shaped sleeve 40 may include one or both ¼ inch bits 54 received within the drivers 44 and 50 thereof; and the 5/16 inch bit 36 received within the other driver 32 thereof. Furthermore, with the inclusion of the impact resistant and/or shock absorbing insert 63, the multi-tool screwdriver 10 is protected from damage when a user strikes the handle 12 with a hammer or other object when the screwdriver 10 is used, for example, as a chisel or punch.

A significant advantage of the multi-tool screwdriver 10 of the present invention is that the multi-tool shaft 16 defines an approximately ⅜ inch or 9 mm hexagonal-shaped driver on one end, and an approximately 5/16 inch or 7 mm hexagonal-shaped driver on the other end, and further, the hexagonal-shaped sleeve 40 is approximately ⅜ inch or 9 mm wide. As a result, the multi-tool shaft 16 and hexagonal-shaped sleeve 40 of the multi-tool screwdriver 10 of the present invention define significantly greater wall thicknesses than do the shafts and sleeves of known prior art multi-tool screwdrivers, thus providing a substantially sturdier construction while nevertheless permitting at least nine tools to be included in one such screwdriver. Additionally, with an impact resistant insert 63 disposed within the handle 12, the multi-tool screwdriver 10 of the present invention offers the advantage and flexibility of allowing the user to employ the multi-tool screwdriver 10 as, for example, a chisel or punch while preventing the shaft 16 and/or any of the bits 26A-B, 36, 54 stored within the handle 12 from penetrating and damaging the handle 12.

As may be recognized by those of ordinary skill in the pertinent art based on the teachings herein, numerous changes may be made to the above-described embodiments of the present invention without departing from its scope as defined in the appended claims. For example, any of numerous different types of materials of construction may be employed. In addition, any of numerous different types of tool bits, defining any of numerous different types of tool heads, that are currently known or that later become known, equally may be employed. Similarly, any of numerous different types of nut drivers that are currently known, or that later become known, equally may be employed. Accordingly, this detailed description of the currently preferred embodiments is to be taken in an illustrative, as opposed to a limiting sense.

What is claimed is:

1. A multi-tool screwdriver, comprising:
a handle defining a shaft opening therein;
a multi-tool shaft defining an outer diameter greater than about ½ of an inch and receivable within the shaft opening of the handle for securing the multi-tool shaft to the handle, the multi-tool shaft including on a first end thereof a first approximately hexagonal-shaped driver defining a first width of about ⅜ of an inch and adapted to receive therein an approximately ⅜ inch wide bit, and including on a second end thereof a second approximately hexagonal-shaped driver defining a second width of about 5/16 of an inch and adapted to receive therein an approximately 5/16 inch wide bit; and
an approximately hexagonal-shaped sleeve defining an external width of about ⅜ of an inch, the sleeve including on a first end thereof a third approximately hexagonal-shaped driver defining a third width between opposing surfaces, and including on a second end thereof a fourth approximately hexagonal-shaped driver defining a fourth width between opposing surfaces, wherein the third and fourth widths are each less than or equal to about ¼ of an inch, the third and fourth approximately hexagonal-shaped drivers are each adapted to receive therein an approximately hexagonal-shaped bit defining a width of about ¼ of an inch or less, and each of the first and second ends of the hexagonal-shaped sleeve are receivable within the first hexagonal-shaped driver of the multi-tool shaft.

2. A multi-tool screwdriver as defined in claim 1, wherein the multi-tool shaft defines a minimum wall thickness at each of the first and second ends thereof of at least approximately 0.04 inch.

3. A multi-tool screwdriver as defined in claim 1, wherein one of the multi-tool shaft and the handle defines a guide protuberance, and the other defines a guide recess for receiving therein the respective guide protuberance with one end of the multi-tool shaft received within the shaft opening of the handle to substantially prevent relative rotation of the multi-tool shaft and handle.

4. A multi-tool screwdriver as defined in claim 1, wherein one of the multi-tool shaft and the handle includes a locking member that is biased into contact with the other of the multi-tool shaft and the handle with one end of the multi-tool shaft received within shaft opening of the handle to resist relative axial movement of the shaft and handle.

5. A multi-tool screwdriver as defined in claim 1, further comprising at least two approximately ¼ inch wide, substantially hexagonal-shaped tool bits receivable within each of the third and fourth approximately hexagonal-shaped drivers of the sleeve, at least one approximately ⅜ inch wide, substantially hexagonal-shaped tool bit receivable within the first approximately hexagonal-shaped driver of the multi-tool shaft, and at least one approximately 5/16 inch wide, substantially hexagonal-shaped tool bit receivable within the second approximately hexagonal-shaped driver of the multi-tool shaft.

6. A multi-tool screwdriver as defined in claim 5, wherein the first end of the multi-tool shaft is receivable within the shaft opening of the handle with either the ⅜ inch bit or the approximately hexagonal-shaped sleeve received within the first driver thereof.

7. A multi-tool screwdriver as defined in claim 5, wherein the approximately hexagonal shaped sleeve including the at least two approximately ¼ inch tool bits received within the third and fourth drivers thereof is receivable within the first driver of the multi-tool shaft and the shaft opening within the handle.

8. A multi-tool screwdriver as defined in claim 5, wherein the at least two ¼ inch tool bits are double ended combination bits; the 5/16 inch tool bit is a double ended combination bit; and the ⅜ inch tool bit is a double ended combination bit.

9. A multi-tool screwdriver as defined in claim 1, further including an impact-resistant insert disposed within the handle

10. A multi-tool screwdriver as defined in claim 9, wherein the handle includes a handle sleeve and a grip disposed over the handle sleeve, the handle sleeve defines an open end and a butt end, and the insert is positioned towards the butt end of the handle sleeve.

11. A multi-tool screwdriver as defined in claim 10, wherein the insert is an approximately cylindrical-shaped steel plug.

12. A multi-tool screwdriver, comprising:
a handle defining a shaft opening therein;
a multi-tool shaft defining an outer diameter greater than about ½ of an inch and receivable within the shaft opening of the handle for securing the multi-tool shaft to the handle, the multi-tool shaft including on a first end thereof a first approximately hexagonal-shaped driver defining a first width within the range of about 0.35 inch to about 0.39 inch and adapted to receive therein a bit defining a width within the range of about 0.35 inch to about 0.39 inch, and including on a second end thereof a second approximately hexagonal-shaped driver defining a second width within the range of about 0.27 inch to about 0.32 inch and adapted to receive therein a bit defining a width within the range of about 0.27 inch to about 0.32 inch; and
an approximately hexagonal-shaped sleeve defining an external width within the range of about 0.35 inch to about 0.39 inch, the sleeve including on a first end thereof a third approximately hexagonal-shaped driver defining a third width between opposing surfaces, and including on a second end thereof a fourth approximately hexagonal-shaped driver defining a fourth width between opposing surfaces, wherein the third and fourth widths are each less than or equal to about ¼ of an inch and the third and fourth approximately hexagonal-shaped drivers are each adapted to receive therein an approximately hexagonal-shaped bit defining a width of about ¼ of an inch or less, and each of the first and second ends of the hexagonal-shaped sleeve are receivable within the first hexagonal-shaped driver of the multi-tool shaft.

13. A multi-tool screwdriver as defined in claim 12, wherein the multi-tool shaft defines a minimum wall thickness of at least approximately 0.04 inch.

14. A multi-tool screwdriver as defined in claim 13, further comprising at least two approximately ¼ inch wide, substantially hexagonal-shaped tool bits receivable within each of the third and fourth approximately hexagonal-shaped drivers of the sleeve, at least one approximately ⅜ inch wide, substantially hexagonal-shaped tool bit receivable within the first approximately hexagonal-shaped driver of the multi-tool shaft, and at least one approximately 5/16 inch wide, substantially hexagonal-shaped tool bit receivable within the second approximately hexagonal-shaped driver of the multi-tool shaft.

15. A multi-tool screwdriver as defined in claim 12, wherein the first width of the multi-tool shaft is within the range of about 9 mm to about 10 mm, the second width of the multi-tool shaft is within the range of about 7 mm to about 8 mm, and the external width of the hexagonal-shaped sleeve is within the range of about 9 mm to about 10 mm.

16. A multi-tool screwdriver as defined in claim 12, further including an impact-resistant insert disposed within the handle

17. A multi-tool screwdriver as defined in claim 16, wherein the handle includes a handle sleeve and a grip disposed over the handle sleeve, the handle sleeve defines an open end and a butt end, and the insert is positioned towards the butt end of the handle sleeve.

18. A multi-tool screwdriver as defined in claim 17, wherein the insert is an approximately cylindrical-shaped steel plug.

19. A multi-tool screwdriver, comprising:
first means for manually gripping the multi-tool screwdriver and defining an opening therein;
second means for supporting on opposite ends thereof a plurality of tool bits, wherein the second means defines an outer diameter greater than about ½ of an inch and is receivable within the opening of the first means for securing the second means to the first means, the second means includes on a first end thereof third means defining an approximately hexagonal shape and a first width within the range of about 0.35 inch to about 0.39 inch for driving a bit defining a width within the range of about 0.35 inch to about 0.39 inch, and includes on a second end thereof fourth means defining an approximately hexagonal shape and a second width within the range of about 0.27 inch to about 0.32 inch for driving a bit defining a width within the range of about 0.27 inch to about 0.32 inch; and
fifth means for supporting on opposite ends thereof a plurality of tool bits, wherein the fifth means defines an approximately hexagonal external shape and an external width within the range of about 0.35 inch to about 0.39 inch, and includes on a first end thereof sixth means defining an approximately hexagonal shape and a third width between opposing surfaces for driving an approximately hexagonal-shaped bit defining a width of about ¼ inch or less, and includes on a second end thereof seventh means defining an approximately hexagonal shape and a third width between opposing surfaces for driving a bit defining a width less than or equal to about ¼ inch, and wherein each of the first and second ends of the fifth means are receivable within the third means.

20. A multi-tool screwdriver as defined in claim 19, wherein the first means is a handle, the second means is a multi-tool shaft, the third means is an approximately hexagonal-shaped driver, the fourth means is an approximately hexagonal-shaped driver, the fifth means is an approximately hexagonal-shaped sleeve, the sixth means is an approximately hexagonal-shaped driver, and the seventh means is an approximately hexagonal-shaped driver.

21. A multi-tool screwdriver as defined in claim 19, further comprising eighth means for preventing relative rotation of the first and second means, and ninth means for resisting relative axial movement of the first and second means.

22. A multi-tool screwdriver as defined in claim 21, wherein the eighth means includes a guide protuberance defined by one of the first and second means, and a guide recess defined by the other of the first and second means for receiving therein the respective guide protuberance with one end of the second means received within the opening of the first means to substantially prevent relative rotation of the first and second means, and the ninth means includes a locking member located on one of the first and second means that is biased into contact with the other of the first and second means with one end of the second means received within the opening of the first means to resist relative axial movement of the first and second means.

23. A multi-tool screwdriver as defined in claim 19, further comprising at least two approximately ¼ inch wide, substantially hexagonal-shaped tool bits receivable within each of the sixth and seventh means, at least one approximately ⅜ inch wide, substantially hexagonal-shaped tool bit receivable within the third means, and at least one approximately 5/16 inch wide, substantially hexagonal-shaped tool bit receivable within the fourth means.

24. A multi-tool screwdriver as defined in claim 19, wherein the first width of the third means is within the range of about 9 mm to about 10 mm, the second width of the fourth means is within the range of about 7 mm to about 8 mm, and the external width of the fifth means is within the range of about 9 mm to about 10 mm.

25. A multi-tool screwdriver as defined in claim 19, further comprising means disposed within the first means for resisting an impact applied to a butt end of the first means.

26. A multi-tool screwdriver as defined in claim 25, wherein the impact resistant means is a steel plug.
